(19) United States
(12) Patent Application Publication
(10) Pub. No.: US 2026/0044856 A1
(43) Pub. Date: Feb. 12, 2026

(54) BLOCKCHAIN TRANSACTION EXECUTION METHODS AND BLOCKCHAIN NODES

(71) Applicant: Ant Blockchain Technology (Shanghai) Co., Ltd., Shanghai (CN)

(72) Inventor: Dayi Yang, Hangzhou (CN)

(73) Assignee: Ant Blockchain Technology (Shanghai) Co., Ltd., Shanghai (CN)

(21) Appl. No.: 19/316,486

(22) Filed: Sep. 2, 2025

Related U.S. Application Data
(63) Continuation of application No. PCT/CN2023/135035, filed on Nov. 29, 2023.

(30) Foreign Application Priority Data
Mar. 31, 2023 (CN) 202310341272.7

(51) Int. Cl. G06Q 20/40; H04L 9/00

(52) U.S. Cl. CPC G06Q 20/401; H04L 9/50

(57) ABSTRACT

Blockchain transaction execution methods, blockchain nodes, and systems are provided. In an example method, a first transaction is obtained, where the first transaction invokes a first contract, contract data of the first contract is stored in a blockchain, the contract data includes a first access information table, and the first access information table includes first storage location information of a first state variable requested to be read by the first contract; the first storage location information is read from the blockchain; and a value of the first state variable is read from the blockchain based on the first storage location information, to execute the first transaction.

### CROSS-REFERENCE TO RELATED APPLICATIONS

This application is a continuation of PCT Application No. PCT/CN2023/135035, filed on Nov. 29, 2023, which claims priority to Chinese Patent Application No. 202310341272.7, filed on Mar. 31, 2023, and each application is hereby incorporated by reference in its entirety.

### TECHNICAL FIELD

Embodiments of this specification pertain to the field of blockchain technologies, and in particular, relate to blockchain transaction execution methods and blockchain nodes.

### BACKGROUND

A blockchain is a novel application model of computer technologies such as distributed data storage, peer-to-peer transmission, consensus mechanisms, and encryption algorithms. In a blockchain system, data blocks are organized into a chain data structure in chronological order, and distributed ledgers that cannot be tampered with or forged are cryptographically ensured. The blockchain has characteristics such as decentralization, tamper-resistance of information, and autonomy, and therefore the blockchain has received increasing attention and applications.

### SUMMARY

An objective of the present disclosure is to provide blockchain transaction execution solutions to improve transaction execution efficiency in a blockchain.

A first aspect of this specification provides a blockchain transaction execution method, performed by a blockchain node, where the method includes: obtaining a first transaction, where the first transaction invokes a first contract, contract data of the first contract is stored in a blockchain, the contract data includes a first access information table, and the first access information table includes first storage location information of a first state variable requested to be read by the first contract; reading the first storage location information from the blockchain; and reading a value of the first state variable from the blockchain based on the first storage location information, to execute the first transaction.

A second aspect of this specification provides a blockchain node, including: an acquisition unit, configured to obtain a first transaction, where the first transaction invokes a first contract, contract data of the first contract is stored in a blockchain, the contract data includes a first access information table, and the first access information table includes first storage location information of a first state variable requested to be read by the first contract; and a reading unit, configured to read the first storage location information from the blockchain, and read a value of the first state variable from the blockchain based on the first storage location information, to execute the first transaction.

A third aspect of this specification provides a computer-readable storage medium. The computer-readable storage medium stores a computer program, and when the computer program is executed in a computer, the computer is enabled to perform the method according to the first aspect.

A fourth aspect of this specification provides a blockchain node, including a memory and a processor. The memory stores executable code, and when the processor executes the executable code, the method according to the first aspect is implemented.

In the solution provided in the embodiments of this specification, read/write information in a contract is pre-stored in the blockchain when a contract is deployed. Therefore, when or before a transaction that invokes the contract is executed, a value of a state variable requested to be read by the transaction can be pre-read based on the read/write information stored in the blockchain. This solution reduces the waiting time for read results during the transaction execution process and improves the processing efficiency of the blockchain.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a schematic diagram of deploying a smart contract, according to some embodiments;

FIG. 2 is a schematic diagram of invoking a smart contract, according to some embodiments;

FIG. 3 is a schematic diagram illustrating a blockchain data storage structure, according to some embodiments;

FIG. 4 is a schematic diagram illustrating a blockchain data storage structure, according to some embodiments;

FIG. 5 is a schematic diagram illustrating an EVM virtual machine module in a transaction processing process, according to some embodiments;

FIG. 6 is a schematic diagram illustrating a slot structure, according to some embodiments;

FIG. 7 is a schematic diagram illustrating a slot structure, according to some embodiments;

FIG. 8 is a flowchart illustrating a method for deploying a contract in a blockchain, according to some embodiments of this specification;

FIG. 9 is a schematic diagram illustrating a contract invoking relationship, according to some embodiments of this specification;

FIG. 10 is a schematic diagram illustrating contract data, according to some embodiments of this specification;

FIG. 11 is a flowchart illustrating a blockchain transaction execution method, according to some embodiments of this specification; and

FIG. 12 is a schematic diagram illustrating an architecture of a blockchain node, according to some embodiments of this specification.

### DESCRIPTION OF EMBODIMENTS

In order to enable persons skilled in the art to better understand the technical solutions in this specification, the technical solutions in embodiments of this specification would be clearly and completely described in combination with the attached drawings in the embodiments of this specification. Clearly, the described embodiments are only partial embodiments of this specification, not all embodiments. On the basis of the embodiments in this specification, all other embodiments obtained by persons having ordinary skill in the art without creative work shall fall within the scope of protection of this specification.

Blockchains are generally classified into three types: public blockchains, private blockchains, and consortium blockchains. In addition, there are combinations of a plurality of types, such as a combination of a private blockchain and a consortium blockchain, and a combination of a consortium blockchain and a public blockchain. The public blockchain has the highest degree of decentralization. Bitcoin and Ethereum are examples of public blockchains. Participants that join the public blockchain can read data records in the blockchain, participate in transactions, contend for ledger permission of a new block, etc. In addition, each participant (represented as a node in the blockchain) can freely join and exit the network and perform related operations. The private blockchain is an opposite of the public blockchain. Write permission of the network is controlled by an organization or an institution, and data read permission is specified by the organization. In short, the private blockchain can be a weakly centralized system, and has few participating nodes with strict restrictions. This type of blockchain is more suitable for internal use of specific institutions. The consortium blockchain lies between the public blockchain and the private blockchain, achieving “partial decentralization”. Each node in the consortium blockchain usually has a corresponding entity organization or institution. Participants are authorized to join the network and form a stakeholder alliance, and jointly maintain the operation of the blockchain.

Most of the public blockchain, the private blockchain, and the consortium blockchain can provide a function of smart contracts. The smart contract in the blockchain is a contract whose execution can be triggered by a transaction in a blockchain system. The smart contract can be defined in a form of code.

Ethereum is used as an example. Supporting users in creating and invoking some complex logic in the Ethereum network is the biggest challenge of Ethereum to be different from the Bitcoin blockchain technology. The core of Ethereum as a programmable blockchain is an Ethereum virtual machine (EVM). Each Ethereum node can run the EVM. The EVM is a Turing-complete virtual machine, which means that various complex logics can be implemented through it. Deploying and invoking smart contracts in Ethereum by users are implemented by the EVM. In fact, the virtual machine directly runs virtual machine code (virtual machine bytecode, or “bytecode”). The smart contracts deployed on the blockchain can be in the form of bytecode.

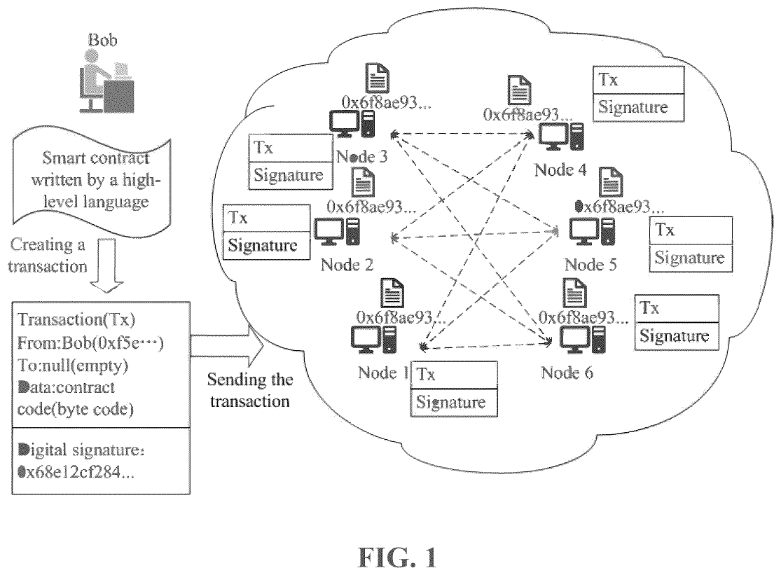

For example, as shown in FIG. 1, after Bob sends a transaction that includes information for creating a smart contract to the Ethereum network, an EVM of node 1 can execute the transaction and generate a corresponding contract instance. “0x6f8ae93 . . . ” in FIG. 1 represents an address of the contract, a Data field of the transaction can store bytecode, and a To field of the transaction is an empty account. After consensus is reached among nodes by using a consensus mechanism, the contract is successfully deployed, and users can invoke the contract subsequently.

After the contract is successfully deployed, a contract account corresponding to the smart contract appears in the blockchain and has a specific address. Contract code and account storage are stored in the contract account. The behavior of the smart contract is controlled by the contract code, while the account storage of the smart contract preserves the state of the contract. In other words, the smart contract enables the generation of a virtual account on the blockchain that includes the contract code and account storage.

As mentioned above, a data field of a transaction including creation of a smart contract can include the bytecode of this smart contract. The bytecode includes a series of bytes, and each byte can identify an operation. Considering the development efficiency, readability, etc., developers can choose a high-level language to write the smart contract code instead of writing bytecode directly. The smart contract code written in the high-level language is compiled by a compiler to generate bytecode, which can be deployed in the blockchain. Ethereum supports many high-level languages, such as Solidity, Serpent, and Lisp-Like Language (LLL).

Solidity is used as an example. Contracts written in Solidity are similar to classes in object-oriented programming languages. A plurality of members (or objects) can be declared in a contract, including a state variable, a function, a function modifier, an event, etc. The state variable is a value stored in the account storage of the smart contract, and is used to keep the state of the contract.

The following is code example 1 of a simple smart contract written in Solidity:

| | |
|---|---|
| 1 | Contract SimpleStorage { |
| 2 | string storedData; |
| 3 | event stored(address from, string s) |
| 4 | function set(string s) { |
| 5 | storedData = s; |
| 6 | stored(msg.sender, s); |
| 7 | } |
| 8 | function get( ) constant returns (string) { |
| 9 | return storedData; |
| 10 | } |
| 11 | } |

### Code Example 1. SimpleStorage Code

In the above-mentioned code example 1, a state variable storedData of a string type is declared in line 2, and an event is declared in line 3. Content stored in the event is an address of an initiator invoking the contract and a string s. A set function is defined in lines 4 to 7, and an input parameter is the string s. An operation performed by the set function includes setting the input parameter to the state variable storedData and generating an event, where content of the event includes the address of the initiator invoking the contract and the string s.

As mentioned above, the state variable is eventually stored in a database. The generated event is generally in the following form:
[topic1][topic2] . . . [topicn][data]

Here, the first topic, namely, topic1, is generally a default value, for example, an identifier of a receipt, and can be a hash value obtained after an event name, an event parameter type, etc. are sequentially concatenated. For topic2 to topicn, existence of each topic depends on whether an Indexed modifier is added when a parameter is defined. If yes, a value of this parameter is a topic in the receipt, but a parameter to which no Indexed modifier is added is placed in data. In the example in the above-mentioned code example 1, when the event is declared in line 3, the two parameters address from and s have no Indexed modifier, and are generally placed in data. The code in line 6 sets data content [msg.sender, s] in the event by using the stored( ) event. As such, for the event operated in line 6, an overall form is as follows:
[topic1: event identifier] [data: msg.sender, s]

A get function is defined in lines 8 to 10. An operation of this function includes returning a value of queried storedData. returns (string) indicates a type of the return value, and a constant modifier represents that the function cannot modify the value of the state variable in the contract.

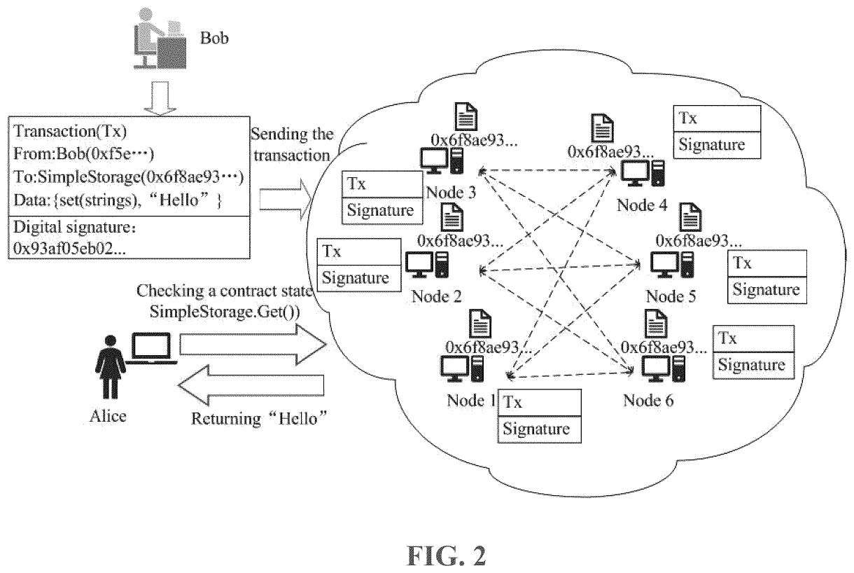

In addition, as shown in FIG. 2, Ethereum is still used as an example. After Bob sends a transaction that includes information for invoking a smart contract to the Ethereum network, an EVM of node 1 can execute the transaction and generate a corresponding contract instance. In FIG. 2, a from field of the transaction is an address of an account that initiates invoking of the smart contract, “0x6f8ae93 . . . ” in a to field represents an address of the invoked smart contract, and a data field of the transaction stores methods and parameters for invoking the smart contract. After the smart contract is invoked, the value of storedData may change. Subsequently, a certain client device can check a current value of storedData by using a certain blockchain node (such as node 6 in FIG. 2).

The smart contract can be executed independently by each node in the blockchain network in a prescribed way, and all execution records and data are stored on the blockchain. Hence, when such transactions are completed, transaction vouchers that cannot be tampered with and cannot be lost are stored on the blockchain.

As mentioned above, storedData in the above-mentioned example is a state variable stored in account storage of a smart contract. In various blockchain networks that introduce smart contracts, such as Ethereum, accounts can generally include two types:

Contract account: The contract account stores executed smart contract code and a value of a state in the smart contract code, and can be activated only through invoking by using an externally owned account.

Externally owned account: The externally owned account is an account of a user.

The design of the externally owned account and the contract account is actually mapping from an account address to an account state. The account state generally includes fields such as Nonce, Balance, Storage root, and CodeHash. Nonce and Balance exist in both the externally owned account and the contract account. CodeHash and Storage root attributes are generally valid only for the contract account.

Nonce is a counter. For the externally owned account, this number represents a quantity of transactions sent from the account address. For the contract account, this number can be a quantity of contracts created by the account.

Balance is an account balance.

Storage root is a hash value of a root node of an MPT tree. This MPT tree organizes storage of state variables of the contract account.

CodeHash is a hash value of the smart contract code. For the contract account, CodeHash is a hash value of the smart contract. For the externally owned account, because the smart contract is not included, the CodeHash field can generally be an empty string/an all-0 string.

A full name of MPT is Merkle Patricia Tree, and is a tree structure that combines Merkle Tree and Patricia Tree (a compressed prefix tree, a more space-saving Trie or dictionary tree). Merkle Tree: The Merkel tree algorithm calculates one Hash value for each transaction, and then hash values are connected in pair to calculate a Hash again, until the Merkle root at the topmost layer is reached. Ethereum uses an improved MPT tree, for example, a 16-ary tree structure, which is also generally referred to as an MPT tree briefly.

A data structure of the MPT tree in Ethereum includes a state trie. The state trie includes a key-value pair (key and value pair, also written as key-value, k-v or kv for short) of storage content corresponding to each account in the Ethereum network. The “key” in the state trie can be a 160-bit identifier (for example, an address of an Ethereum account or a part of a hash value of the address, collectively referred to as an account address below), and the account address is distributed in storage from the root node of the state trie to the leaf node. The “value” in the state trie is generated by encoding information of the Ethereum account (using a Recursive-Length Prefix encoding (RLP) method). As mentioned above, for the externally owned account, the value includes nonce and balance. For the contract account, the value includes nonce, balance, codehash, and storageroot.

The contract account is used to store a state related to the smart contract. After the smart contract is deployed on the blockchain, a corresponding contract account is generated. This contract account typically has some states, and these states are defined by state variables in the smart contract and generate new values when the smart contract is executed. The smart contract is generally a contract that can automatically execute terms and that is defined in the code form in a blockchain environment. Once a certain event triggers the terms in the contract (an execution condition is satisfied), the code can be executed automatically. In the blockchain, the related state of the contract is stored in the storage trie, and a hash value of the root node of the storage trie is stored in the above-mentioned storageroot, thereby locking all the states of the contract to the contract account by using the hash. The storage trie is also an MPT tree structure that stores key-value mapping from a state address to a state value. Partial information from the root node to the leaf node of the storage trie is sequentially arranged to store an address of a state, and a value of the state is stored in the leaf node.

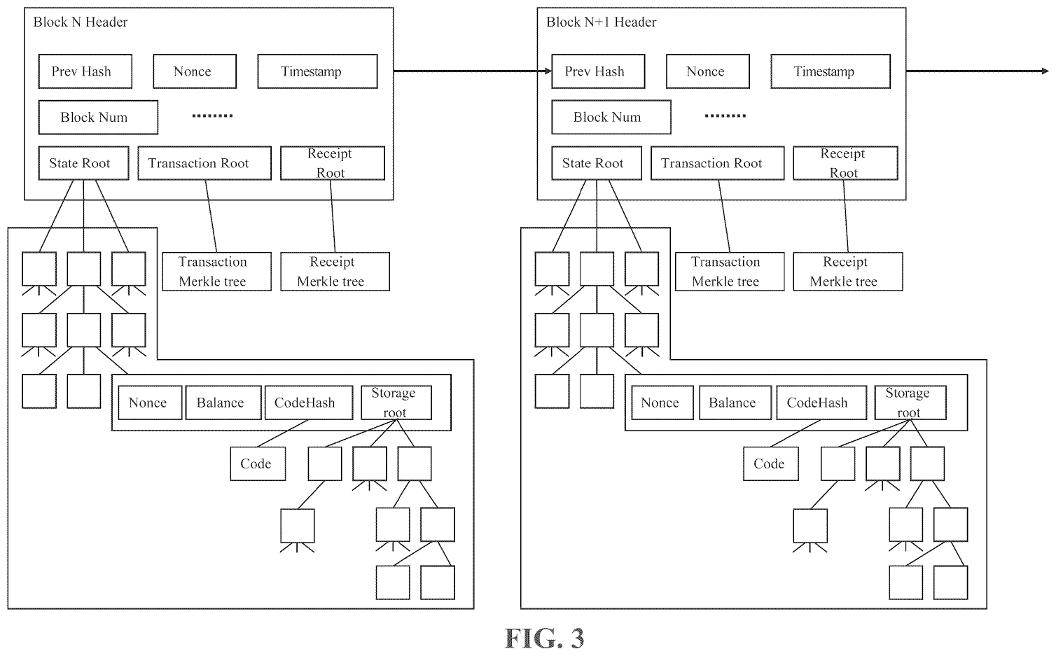

In some blockchain data storage shown in FIG. 3, a block header of each block includes several fields, such as a previous block hash previous_Hash (Prev Hash in the figure), a Nonce (this Nonce is not a random number in some blockchain systems or the Nonce in the block header is not enabled in some blockchain systems), a Timestamp, a block number Block Num, a state root hash State_Root, a transaction root hash Transaction_Root, a receipt root hash Receipt_Root, etc. Prev Hash in a block header of a next block (for example, block N+1) points to a previous block (for example, block N), that is, a hash value of the previous block. As such, locking of the previous block by the next block is implemented in the blockchain through the block header. State_Root, Transaction_Root, and Receipt_Root respectively lock a state set, a transaction set, and a receipt set. The state set, the transaction set, and the receipt set organize states, transactions, and receipts in a tree form, respectively. Generally, they can have the same tree structure, or can have different tree structures. For example, the same MPT structure is used in Ethereum. In some tree structures including a state set of a smart contract, such as Ethereum, there are two levels of MPT structures: A leaf node of an upper-level MPT structure includes two types: an externally owned account and a contract account. Each contract account includes a next-level MPT structure, and a next-level leaf node includes a value of a state in the contract account.

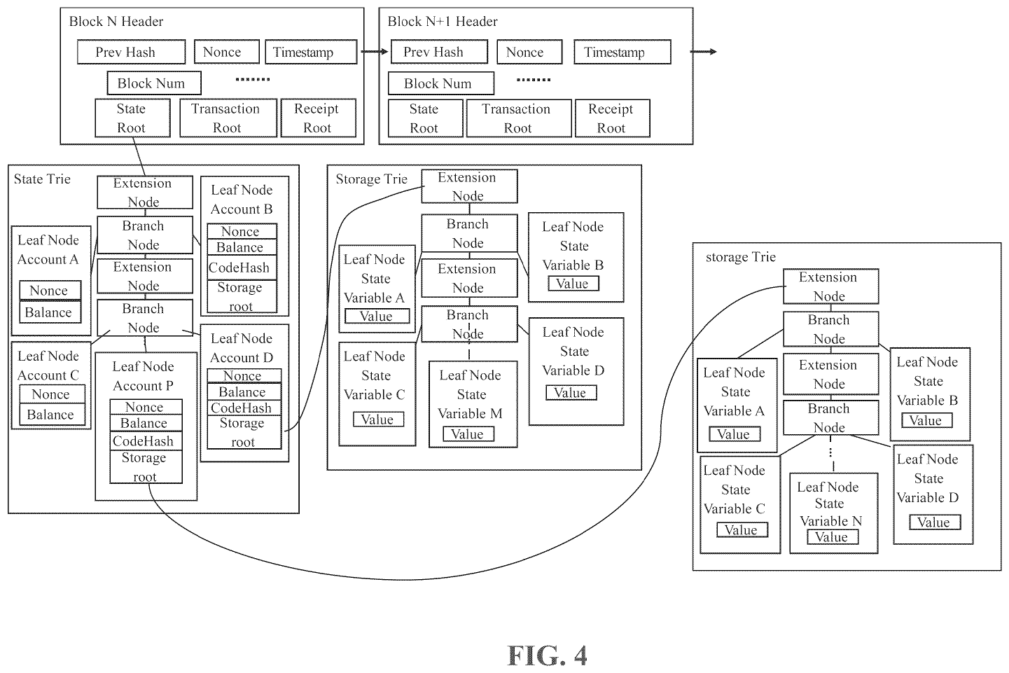

FIG. 4 is a schematic structural diagram of blockchain data storage. Still, Ethereum is used as an example. Referring to FIG. 3, state_root is a hash value of a root of an MPT tree including states of all accounts in a current block, that is, it is a state trie in an MPT form that points to state_root. A root node of the MPT tree is generally an extension node or a branch node, and state_root generally stores a hash value of the root node. The root node can be connected to one or more lower layers of Extension Nodes/Branch Nodes, and these layers of tree nodes can be collectively referred to as Intermediate Nodes. A part of values from the root node of the MPT to each node in the leaf nodes can be sequentially concatenated to form an account address and used as a key. Account information stored in the leaf node is a value corresponding to the account address, and as such, a key-value pair is formed. The key can also be a part obtained after sha3(Address), that is, a part of a hash value of the account address (for example, the hash algorithm uses the sha3 algorithm). A value stored therein can be rlp(Account), that is, a rlp code of account information. The account information is four-tuples composed of [nonce, balance, storageRoot, codeHash]. As mentioned above, for an externally owned account, there are generally only two items: nonce and balance. By default, the storageRoot and codeHash fields store a null string or an all-0 string. That is, the externally owned account does not store a contract, nor does it store a state variable generated after the contract is executed. The contract account generally includes Nonce, Balance, Storage root, and CodeHash. Nonce is a transaction counter of the contract account. Balance is an account balance. Storage root corresponds to another MPT, and contract-related state information can be linked through the Storage root. CodeHash is a hash value of a contract code. Whether for an externally owned account or a contract account, account information is generally located in a separate leaf node. From the Extension Node/Branch Node of the root node to the leaf node of each account, there may be several branch nodes and extension nodes therebetween.

The state trie can be a tree in the MPT form, usually a 16-ary tree, that is, each layer can have up to 16 child nodes. The Extension Node is configured to store a common prefix. Generally, the extension node has one child node, and the child node can be a Branch Node. The Branch Node can have up to 16 child nodes, which may include an Extension Node and/or a Leaf Node.

For a contract account in the state trie, storage_Root thereof points to another tree also in the MPT form, and data of a state variable involved in contract execution are stored therein. The tree in the MPT form that storage_Root points to is a Storage Trie, that is, a hash value of a root node of the Storage Trie. Generally, the Storage Trie stores a key-value pair. The key indicates an address of a state variable, a value thereof can be a result obtained after specific rule processing is performed on a location at which the state variable is declared in the contract (a value counted from 0), for example, sha3(location at which the state variable is declared) or sha3(location at which the contract name+the state variable are declared). The value is used to store a value of the state variable (for example, a value encoded by RLP). A part of data stored on a path from the root node to the leaf node through an intermediate node are connected to form the key, and the value is stored in the leaf node. As mentioned above, this Storage trie can also be a tree in the MPT form, and is generally also a 16-ary tree. That is, a Branch Node can have up to 16 child nodes, and the child nodes may include an Extension Node and/or a Leaf Node. The Extension Node generally can have one child node, and the child node can be a Branch Node or a Leaf Node.

For example, in FIG. 4, the Leaf Node Account P of state trie is a contract account, and a Storage Root thereof locks all states in the contract storage. These states are organized as an MPT tree with a tree structure such as Storage trie linked by the Storage Root. In the linked Storage trie, leaf node state variable N is used as an example, for example, is a value of storedData in the above-mentioned contract code example. In this case, a key thereof can be but is not limited to sha3(location at which storedData is declared), and a value thereof is s (for brevity, an encoding format of the value is omitted here, for example, RLP, which is similar below and is not described later). A value sequence of the key is distributed in a root node to a leaf node (that is, Leaf Node Variable N) of the storage Trie.

For another example, for Leaf Node Account C in the state Trie in FIG. 4, the account is an externally owned account, and the key of the account is sha3(Address C), that is, a hash value of an address of the account C (the hash algorithm uses, for example, the sha3 algorithm), and a value stored thereby can be (Account), where account information account is two-tuples formed by [nonce, balance]. As mentioned earlier, because Account C is an externally owned account, account information thereof includes two items: nonce and balance (codehash and storage root are not included here, and a similar case exists below). For example, for an externally owned account, if nonce is 20 and Balance is 4550, nonce=20 and balance=4550 are stored in the leaf node Leaf Node State Variable C. The address of the Account C is key, and its values are distributed in order from the root node of the state Trie to the leaf node (that is, Leaf Node Variable C).

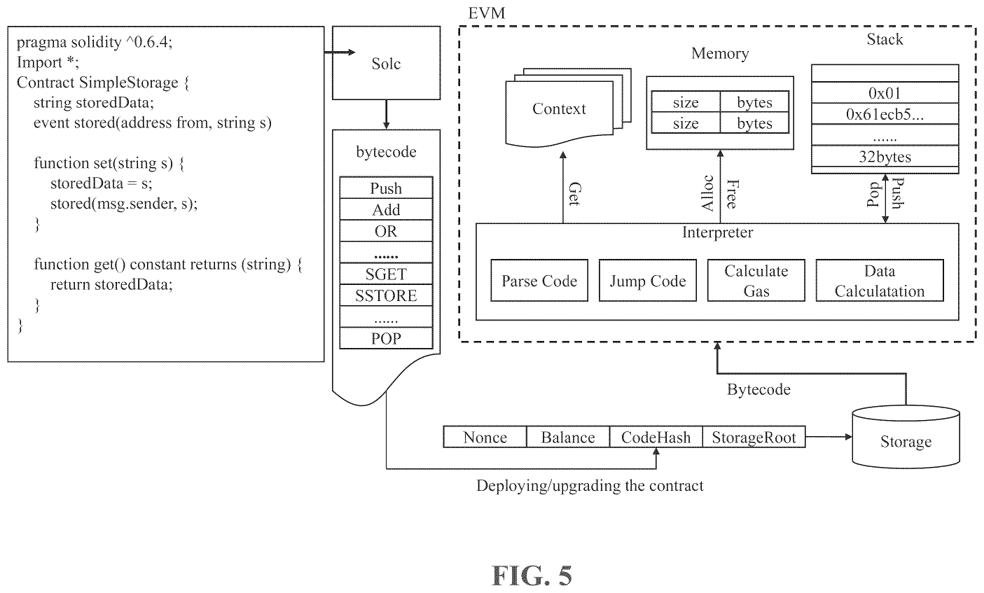

As mentioned above, after a transaction for creating a smart contract is sent to a blockchain, after consensus is reached on the transaction in the blockchain, each node of the blockchain can execute the transaction. At this time, a contract account corresponding to the smart contract appears on the blockchain (including, such as an identity, Identity, of the account, a hash value, Codehash, of the contract, and a root, StorageRoot, of the contract storage), and has a specific address. The contract code and account storage can be stored in the storage of the contract account, as shown in FIG. 5. The behavior of the smart contract is controlled by the contract code, while the account storage of the smart contract preserves the state of the contract. In other words, the smart contract enables the generation of a virtual account on the blockchain that includes the contract code and account storage. For a contract deployment transaction or a contract update transaction, the value of Codehash will be generated or changed. Subsequently, the blockchain node can receive a transaction request invoking the deployed smart contract, and the transaction request can include the address of the invoked contract, the function in the invoked contract, and the input parameters. Generally, after the transaction request reaches consensus, each node of the blockchain can independently execute the specially invoked smart contract.

The left side of FIG. 5 is an example of a smart contract written in solidity and its compilation and execution process. The smart contract is compiled by a compiler to generate a bytecode. solc in the drawing is a solidity's command-line compiler. The Ethereum smart contract compiled by solidity can be compiled by solc, a command-line tool with parameters, to generate the bytecode that can be run on the EVM. After the process of deploying the contract in FIG. 1 above, the smart contract can be successfully created on the blockchain. After the contract is deployed, a contract account corresponding to the smart contract is generated on the blockchain. The contract account includes, for example, a contract counter Nonce, an account balance, a hash value Codehash of a contract bytecode, and a root StorageRoot stored in the contract. The contract will have a specific address on the blockchain, that is, the contract address.

The contract address is obtained in Ethereum, for example, by performing hash calculation according to an address of an externally owned account on which the contract is deployed and a counter nonce thereof. Specifically, for example, it is sha3(rlp.encode([address_sender, nonce])) (rlp is an encoding format as described above, and can be replaced with another encoding format in different blockchains, or even not re-encoded, and therefore rlp is omitted subsequently). Sha3 is a type of hash algorithm, for example, an algorithm such as often used keccak256. rlp represents an encoding format as described above, and rlp.encode([address_sender, nonce]) represents performing rlp encoding on content in the parentheses. [address_sender, nonce] in the parentheses indicates that the two fields of the address address_sender of the externally owned account on which the contract is deployed and its counter value nonce are sequentially concatenated. For example, by using the keccak256 algorithm, a hash value with a length of 256 bits can be obtained, and an address (for example, the first 20 bytes) of a deployed contract on a blockchain can be obtained according to the hash value. 256 bits is 32 bytes. When deployment is complete, the Balance of the account can be set to a default value 0 or. The hash value Codehash of the contract bytecode can be obtained by performing hash calculation on the contract bytecode on the blockchain platform. The root StorageRoot stored in the contract can be a default value, or can be a hash value calculated according to a root node of a lower-layer storage Trie. This generally depends on whether an initialization operation is performed in a deployed contract, for example, the initialization operation is performing a constructor function in the contract. If the deployed contract includes the constructor function, it generally includes initialization of some state variables that are ultimately stored in the underlying database. The initialization can be performed on a virtual machine. After initialization, the state variable, as described in the above-mentioned content, can construct an MPT tree, so as to obtain a root node of the MPT tree, and further obtain a hash value of the root node. If the deployed contract does not include the constructor function, a specific function can not be executed, but a default value, such as a hash value of empty content, is assigned to the StorageRoot by the blockchain platform.

After the contract is deployed, as described above, the contract can be subsequently invoked. As shown in FIG. 2, after Bob initiates a transaction invoking a smart contract to an Ethereum network, the contract is executed, thereby setting the state variable to a string “hello”.

The execution of the contract can be specifically shown in FIG. 5. For example, a transaction invoking the contract in FIG. 2 is sent to the blockchain network, and after consensus is reached, each node can execute the transaction. The to field of the transaction indicates the address of the invoked contract. Any node can find the storage of the contract account according to the address of the contract, and then can read the Codehash from the storage of the contract account, so as to find the corresponding contract bytecode according to the Codehash. The node can load the bytecode of the contract from the storage to the virtual machine. Furthermore, it is interpreted and executed by an interpreter, for example, including: parsing the bytecode of the invoked contract (parse, such as parsing Push, Add, SGET, SSTORE, and Pop), to obtain OPcode and functions, storing these OPcode to a memory opened by the virtual machine (alloc in the figure, after the program is executed, a corresponding memory releasing operation, for example, Free in the drawing), and at the same time, also obtaining a JumpCode of the invoked function in the memory. Generally, after calculating the Gas needed to be consumed for executing the contract and Gas being sufficient, it is jumped to the corresponding address of Memory to obtain the OPcode of the invoked function and start to execute. Data Computation, push-in/push-out Stack and other operations are performed on the data operated by the OPcode of the invoked function, to complete the data computation. In this process, some contract context information may also be needed, such as the block number, and information of an initiator for invoking the contract; the information can be obtained from the Context (Get operation). Finally, the generated state is stored in a database storage by invoking a storage interface. It is worthwhile to note that in the process of contract creation, it may also produce the execution of some functions in the contract, for example, the function of an initialization operation. In this case, the code will also be parsed, a jump instruction will be generated and stored into the Memory, the Stack will be operated, etc.

By using the above-mentioned process, the virtual machine loads and executes a bytecode of a contract, may generate a state and/or a read state, and therefore needs to access the underlying database. The virtual machine needs to conveniently access the underlying KV database. To access the KV database, a pointer-like data access capability is generally used. For example, in Ethereum, if a value corresponding to a key needs to be read from a KV database, a key of the data needs to be known before access.

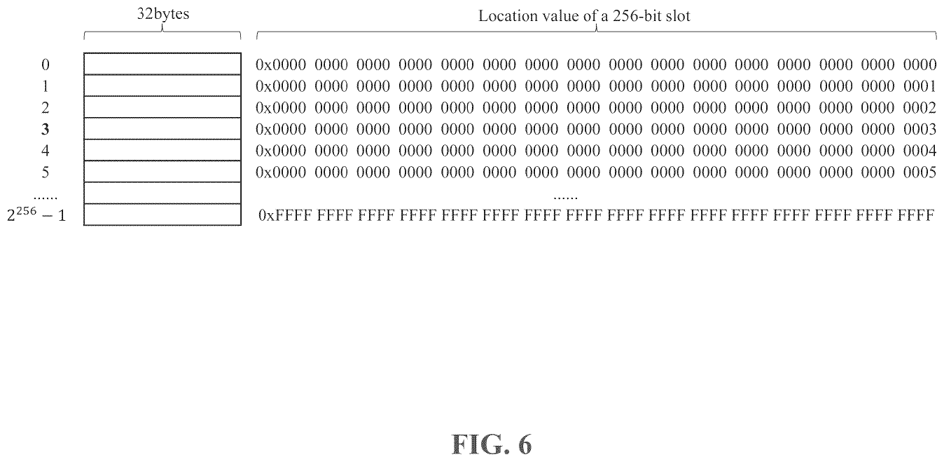

Each contract generally has its own virtual storage space. A capacity of the virtual storage space can be a very large array, for example, an array of 2²⁵⁶ elements, numbered from 0 to 2²⁵⁶−1. Each element can occupy a specific length, for example, 32 bytes. Each element is referred to as a slot here. FIG. 6 is a schematic diagram of a slot structure in an embodiment. It is worthwhile to note that a storage space of a total of 2²⁵⁶ slots is a total capacity of the virtual space, that is, an unused slot does not occupy an actual storage space of the underlying database.

In a process in which the virtual machine executes the contract bytecode, a slot location of the same state variable in the above-mentioned virtual storage space needs to be fixed, so the key generated by the contract execution can be fixed. This “fixed” is usually fixed after the contract code is determined. Therefore, fixing of the location of the state variable is usually determined in a compiler compilation phase, and is not directly related to the virtual machine.

A compiler compilation process can roughly include steps such as generating an abstract syntax tree, performing lexical/syntax analysis according to the abstract syntax tree, filling a symbol according to a symbol table, semantic analysis, and code generation. The abstract syntax tree includes a plurality of nodes arranged in order, and the plurality of nodes correspond to a plurality of objects declared in the contract. The arrangement orders of the plurality of nodes correspond to locations at which the plurality of objects are declared in the contract, and the plurality of objects include the first state variable. In this phase of performing lexical/syntax analysis according to the abstract syntax tree, the slot location information of the state variable of the contract can be generated. Assume that the code of contract C1 is as follows:

```
Contract C1 {
  unit256 A;
bool B;
//mapping from token ID to owner
mappping(uint256 => address) tokenOwner
//mapping from owner to number of owned token
mappping(uint256 => Counter) ownedTokensCount
  function setA(uint256 x) public {
    A = x;
  }
  function getA( ) public view returns(unit256) {
    return A;
  }
  function setB(bool t) public {
    B= t;
  }
  function getB( ) public view returns(bool) {
    return B;
  }
  function mint(address to,uint256 tokenid) public {
    tokenOwner[tokenid]=to;
    ownedTokensCount[to],increment( )
  }
}
```

### Code Example 2. Solidity Code of Contract C1

For example, the following abstract syntax tree is generated according to the contract code: In the abstract syntax tree, information about an object is placed in a node. These objects include, for example, state variables A, B, and mapping relationships “tokenOwner“and” OwnedTokensCount.” The plurality of nodes corresponding to the plurality of objects are arranged in an order of declaring the objects in the contract. For example, the 0th node in the abstract syntax tree corresponds to state variable A, the first node in the abstract syntax tree corresponds to state variable B, the second node in the abstract syntax tree corresponds to mapping relationship tokenOwner, and the third node in the abstract syntax tree corresponds to mapping relationship OwnedTokensCount. Each node further contains several pieces of information. Overall, information inside a node can be referred to as node information of an abstract syntax tree.

For the abstract syntax tree of contract C1, node locations of two state variables A and B in contract C1 in the abstract syntax tree are respectively 0 and 1, and can correspond to slots in the following two locations in FIG. 6:
0x0000 0000 0000 0000 0000 0000 0000 0000 0000 0000 0000 0000 0000 0000 0000 0000
0x0000 0000 0000 0000 0000 0000 0000 0000 0000 0000 0000 0000 0000 0000 0000 0001

Each of the above two slot locations is 256 bits, and is represented as 32 bytes in hexadecimal (0x). After 0x, 4 consecutive hexadecimal numbers in each segment separated by spaces are used to represent 2 bytes. Therefore, there are a total of 16 such segments.

As such, in the contract bytecode obtained by compiler compiling, the two locations in the slot can be respectively used to replace identifiers of two state variables, for example, the above-mentioned two 256 bits respectively replace A and B. As such, when the data type is a value of a fixed size, a storage location can be pre-allocated to each data to be stored according to a field sorting sequence during compilation, which is equivalent to specifying a fixed data pointer in advance.

In the process in which the virtual machine performs loading and executes the contract bytecode, an operation on A is an operation on a slot location corresponding to 0x000 . . . 00 (that is, a location 0 of the above-mentioned slot, and an ellipsis is used to replace a relatively large quantity of 0s in the middle). Similarly, an operation on B is an operation on a slot location of 0x000 . . . 01.

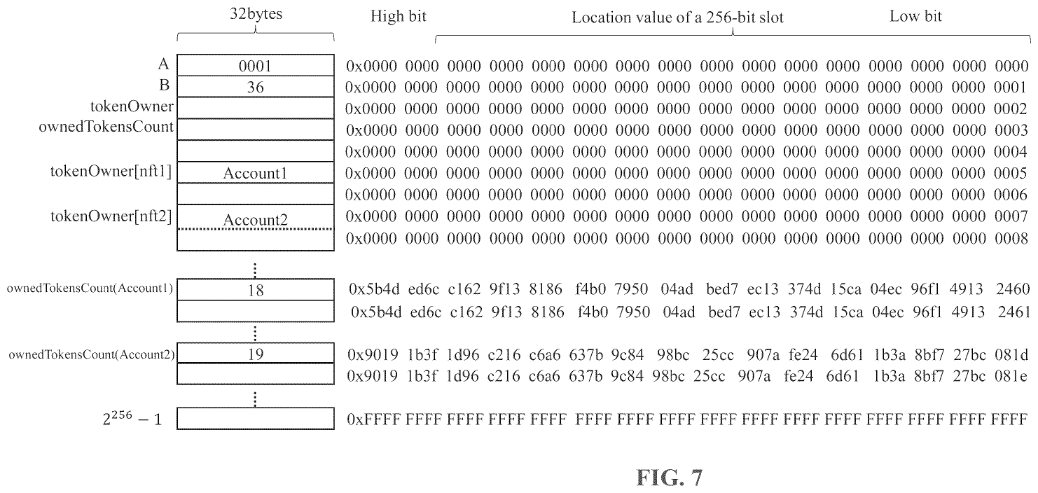

FIG. 7 is a schematic diagram of an operation on a slot. As shown in FIG. 7, for example, for a transaction that invokes contract C1, a setA(function in the contract is invoked, and an input parameter is a string “0001”. In the process in which the virtual machine executes the transaction, 0001 is stored in the slot location of 0x000 . . . 01. Specifically, the virtual machine can press the slot of the 32-byte 0x000 . . . 01 into the stack, and then press the corresponding value into the stack. In the interpretation and execution process, the OPcode of the invoked function is obtained from the memory, and execution starts. According to the first-in-first-out or last-in-first-out feature of the stack, the value is ejected from the stack, and then the slot is ejected from the stack, forming a slot-value pair. Then, the contract virtual machine executes the current opcode, that is, writes the value into the storage of the slot location. It can be understood that the slot is equivalent to a number and can be used to uniquely identify a state variable of a contract during execution of the contract. In the above-mentioned process, the stack generally uses 32 bytes as a storage unit, which is equal to a length of one slot. A corresponding value may be less than, equal to, or greater than 32 bytes, and the value may occupy one or more units in the stack.

As shown in FIG. 7, for example, for a transaction that invokes contract C1, a setB( ) function in the contract is invoked, and an input parameter is “36”. In the process in which the virtual machine executes the transaction, 36 is stored in the slot of 0x000 . . . 02.

The above-mentioned two contract execution results can be simply represented as follows:

$$0 \times 000 … 00 : 0001 \qquad ( 1 )$$

$$0 \times 000 … 01 : 36 \qquad ( 2 )$$

After the virtual machine completes execution, the virtual machine or the blockchain platform can convert slots of two slot-value key-value pairs (1) and (2) into state keys. Specifically, the state key (that is, the storage key of the state variable in the storage trie) can be obtained in a manner of concatenating the contract address+slot location. For example, the address length of contract C1 is 20 bytes, which is 0x3321 dcaf 8911 d384 2e14 a7a4 15be 2fb1 a337 f43e. After the contract address+slot location are concatenated,

(1) The state key of the corresponding state variable A is:
0x3321dcaf8911d3842e14a7a415be2fb1a337f43e0000000000000000000000000000 000000000000000000000000000000000000

(2) The state key of the corresponding state variable B is:
0x3321dcaf8911d3842e14a7a415be2fb1a337f43e0000000000000000000000000000 000000000000000000000000000000000001

Thereafter, the blockchain node can store these generated state key-value in the underlying database. Specifically, the blockchain node can include a tree construction module and a state database module. The tree construction module can convert these keys to the storage trie shown in FIG. 4 and construct the value in state key-value into a certain leaf node of this MPT tree. It is worthwhile to note that, as described above, the state key is split into several segments which are sequentially stored in tree nodes in a direction from the root of the storage trie to the leaf node. Each tree node storing which segment of the state key depends on the common prefix between the state key and another state key on the tree. From this leaf node up to the root node through the intermediate node, a series of hash values change. The tree construction module constructs the kv of these tree nodes. Further, the tree construction module sends these changed tree node kv to the state database module, and finally the state database module stores them in the state database.

In the above-mentioned process, the slot of the state variable is fixed in the compilation phase, and is determined by the contract address and the slot location of the state variable as described above. The state key can be obtained by concatenating the contract address and the slot. As such, when the same contract is run, the same slot is used for reading and writing the same state variable, and a fixed state key is corresponding thereto.

It is worthwhile to note that state variables A and B in the above-mentioned example are respectively of types uint256 and bool, where uint256 is 256 bits, that is, 32 bytes, and bool is 1 byte. The types of these state variables determine that the length of the data is fixed or the data have a fixed length. In addition, the types of uint, uint8, and uint128 also have a fixed length. A specified quantity of arrays including fixed-length elements also have a fixed length. For example, uint[2] includes two elements. Each element is of the uint type having 32 bytes. Therefore, uint[2] is 64 bytes as a whole.

In addition to fixed-length data storage, there is an indeterminate length, or a data size cannot be predicted. In this case, the slot location cannot be directly determined during compilation in a fixed length manner, but a different solution is used.

For example, in contract C1, mappping(uint256=>address) tokenOwner, and mappping(uint256=>Counter) OwnedTokensCount are defined after state variables A and B, that is, a mapping relationship, where the mapping relationship is a data type of an indeterminate length. mappping(uint256=>address) tokenOwner is used as an example, and tokenOwner is the name of the mapping relationship.

For example, the mint function in contract C1 is used to cast an NFT resource. An incoming parameter address to thereof is a receiver account address of the cast NFT resource, and token id is the identifier of the cast NFT resource. In the mint function, mapping elements tokenOwner[tokenid]=to, OwnedTokensCount[to],increment( ) are defined based on the previously defined mapping relationship. The mapping elements are state variables and are stored in the state database. tokenOwner[tokenid]=to is used as an example. tokenid and to are two incoming parameters of the mint function, and tokenid can also be referred to as the key of the mapping relationship tokenOwner.

As shown in FIG. 7, when the contract code is compiled, slot 0x000 . . . 02 can be allocated to the name tokenOwner of the mapping relationship according to the location (that is, the second location) of the node corresponding to the mapping relationship tokenOwner in the abstract syntax tree. Because tokenOwner is not a state variable, there is no value in the slot. Similarly, a slot whose location value is 0x000 . . . 03 can be allocated to the mapping relationship OwnedTokensCount.

When executing contract C1, the virtual machine can uniquely determine, according to the key of the mapping relationship and the slot of the mapping relationship name, the slot of the mapping element corresponding to the key. The slot is, for example, keccak256(key.slot), where “.” is a concatenation symbol, The slot after “.” is the location of the slot in which the mapping relationship name is located. A quantity of mapping elements in the mapping relationship is uncertain, and lengths of key and value in the elements are also uncertain. For example, after contract C1 is invoked several times, there may be two elements in the mapping relationship tokenowner, which are respectively:
tokenowner [“nft1” ]=Account1;
tokenowner[“nft2” ]=Account2;

The key of the first mapping element in the mapping relationship tokenOwner is nft1, and the value is Account1. The slot location of the corresponding mapping element tokenOwner[nft1] can be keccak256(“nft1”.0x000 . . . 02), and the value (for example, the data length of the value is greater than 32 bytes) can be stored in one or more consecutive slots starting from this location. Similarly, the key of the second mapping element in the mapping relationship tokenOwner is nft2, and the value is Account2. The slot location of the corresponding mapping element tokenOwner[nft2] can be keccak256(“nft2”.0x000 . . . 02), and the value (for example, the data length of the value is greater than 32 bytes) can be stored in one or more consecutive slots starting from this location.

For example, the length of the value of the tokenOwner[nft1] is less than 32 bytes, and the length of the value of tokenOwner[nft2] is greater than 32 bytes and less than 64 bytes.

As shown in FIG. 7, the length of the value of tokenOwner[nft1] is less than 32 bytes, and the value can be stored in one slot. The location of the slot is, for example, the value of keccak256(“nft1”, 0x000 . . . 02), for example,
0x000 . . . 05

Assume that the length of the value of tokenOwner[nft2] is greater than 32 bytes and less than 64 bytes, and the value can be stored in two consecutive slots. The start location of the two slots is, for example, the value of keccak256(“nft2”, 0x000 . . . 02). Locations of the two slots are, for example:
0x000 . . . 07
0x000 . . . 08.

Similarly, when executing contract C1, the virtual machine can uniquely determine the slot of each element, that is, keccak256(“to”.0x000 . . . 03), according to the key of mapping element OwnedTokensCount[to] and the slot of mapping relationship OwnedTokensCount. For example, as shown in FIG. 7, it can be determined that the slot of OwnedTokensCount[Account1] is:
0x5b4d ed6c c162 9f13 8186 f4b0 7950 04ad bed7 ec13 374d 15ca 04ec 96f1 4913 2460

It can be determined that the slot of OwnedTokensCount[Account2] is:
0x9019 1b3f 1d96 c216 c6a6 637b 9c84 98bc 25cc 907a fe24 6d61 1b3a 8bf7 27bc 081d

That is, for a contract including a mapping relationship, after a transaction invokes the contract and defines a mapping element, the slot of the mapping element can be uniquely determined according to the key of the mapping element in the transaction and the slot of the mapping relationship.

In the blockchain technology field, when a virtual machine executes a transaction invoking a contract, the value of a state variable requested to be read in the contract is read from a state database according to an execution sequence of a contract bytecode. When state reading is performed, the virtual machine synchronizes an access result to be stored, and continues to perform a subsequent step after the access result is obtained, that is, in this process, reading a plurality of state variables is serial. However, reading the state database usually takes a very long time, thereby reducing overall execution efficiency.

Therefore, an embodiment of this specification provides a transaction execution method. Read/write information in a contract is pre-stored in a blockchain when the contract is deployed, so before a transaction invoking the contract is executed, a plurality of state variables requested to be read in the contract can be pre-read according to the read/write information stored in the blockchain, and reading of the plurality of state variables can be performed in parallel, thereby improving processing efficiency of the blockchain.

FIG. 8 is a flowchart illustrating a method for deploying a contract in a blockchain, according to some embodiments of this specification. The method can be performed by any blockchain node in the blockchain. The method includes the following steps S810-S820.

First, in step S810, a blockchain node receives transaction Tx1 used to deploy contract Contract1, where the transaction Tx1 includes contract data of a contract to be deployed, and the contract data include an access information table and/or an invoking information table.

As described above, the contract deployer can compile the solidity code of contract Contract1 using a compiler to generate a bytecode capable of being run in a virtual machine (e.g., EVM). In a process of compiling the contract code, in a case in which contract Contract1 includes a declared object, the compiler generates a corresponding object identifier for the declared object in the contract according to a predetermined rule, and converts the name of the declared object into the object identifier corresponding to the object in the generated bytecode.

The object identifier is, for example, the above-mentioned slot, and the object declared in the contract includes, for example, an object such as a state variable or a mapping relationship. It can be understood that the object identifier is not limited to the slot, but can be an identifier generated by using another predetermined rule and used to uniquely identify the object. For example, the object identifier can be generated based on an attribute such as the name or the length of the object. In an implementation, the object declared in the contract is a state variable, and the object identifier can be the key of the state variable in the state database.

The slot is used as an example. After the compiler generates the slot of each object declared in the contract, the compiler can generate, based on the identifier of each object, storage location information of a state variable accessed by the contract.

In a case, state variable A accessed by the contract is a fixed-length variable, and the storage location information of state variable A can be the slot of the state variable included in the contract bytecode.

In another case, the state variable (for example, variable B) accessed by the contract is a state variable corresponding to a mapping relationship, and storage location information thereof can include parameter information associated with the mapping relationship and the slot of the mapping relationship in the contract bytecode. The mapping relationship is, for example, associated with a sending account of a transaction or a value of a storage object in an incoming parameter from a transaction for the contract, so the parameter information is, for example, used to indicate the sending account of the transaction or the incoming parameter from the transaction for the contract. For example, contract Contract1 includes mapping relationship a[ ], where the mapping relationship is used to map a sending account of a transaction invoking the contract to state variable a[from], and the storage location information of state variable a[from] can include: “slota, {index 0}”, where slota is the slot of mapping relationship a, and index0 is used to indicate a from field of the transaction.

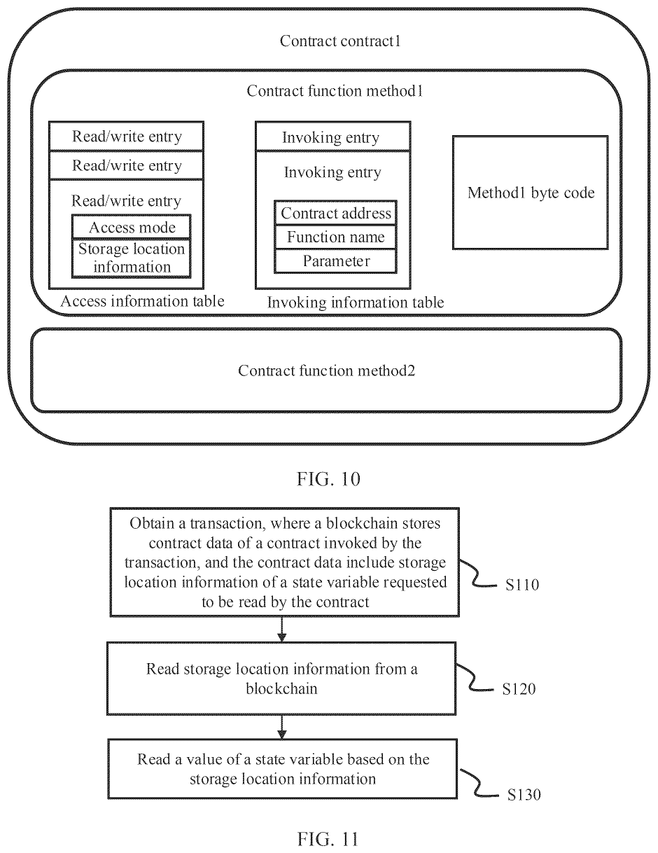

In a process of compiling the contract code, in addition to determining storage location information of each state variable, the compiler can further determine an access mode of the state variable in the contract according to the contract code. The access mode includes, for example, a read mode, a write mode, and a read/write mode. Therefore, the compiler can generate an access information table of the contract. Referring to the access information table in the contract data shown in FIG. 10, the access information table can include access modes and storage location information of each state variable that is requested to be accessed in the contract.

In an implementation, the contract includes a plurality of functions, and the compiler can generate an access information table corresponding to each function. For example, contract Contract1 includes function method1, function method2, etc. The compiler can separately generate an access information table corresponding to function method1 and an access information table corresponding to function method2.

In the case of invoking another contract in contract Contract1, the compiler can also determine the information of the contract invoked in the contract according to the contract code of contract Contract1. Specifically, the compiler can generate contract invoking information corresponding to each function in contract Contract1. For example, contract Contract1 includes function method1, function method2, etc. The compiler can separately generate an invoking information table corresponding to function method1 and an invoking information table corresponding to function method2.

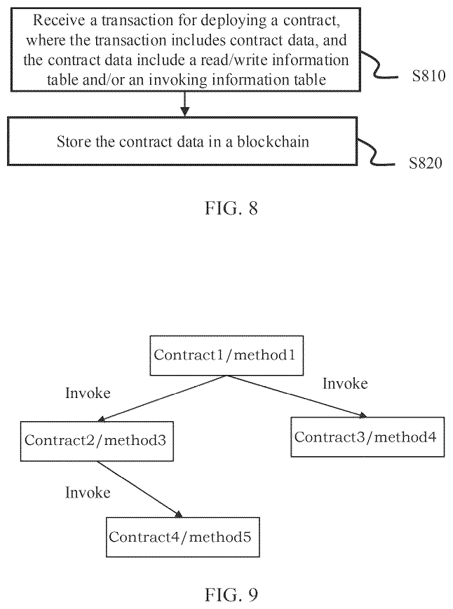

Assume that method1 of contract Contract1 includes a schematic diagram of an invoking relationship shown in FIG. 9. As shown in FIG. 9, function method1 in contract Contract1 invokes function method3 in contract Contract2 and function method4 in contract Contract3, and function method3 in contract Contract2 invokes function method5 in contract Contract4. For method1, the compiler can obtain, according to the contract code of contract Contract1, a contract address of Contract2 invoked by Contract1, a function name of function method3, and an incoming parameter from function method1 for function method3 in Contract2; and a contract address of Contract3, a function name of function method4, and an incoming parameter from function method1 for function method4 in Contract3. Therefore, the invoking information table of function method1 can be generated. The invoking information table corresponding to function method1 includes the contract address of contract Contract2 invoked in function method1, the function name of function method3 in contract Contract2, and the incoming parameter for function method3 in function method1; and the contract address of contract Contract3 invoked in function method1, the function name of function method4 in contract Contract3, and the incoming parameter for function method4 in function method1.

After performing the operations described above, the compiler can generate contract data for contract Contract1, and the contract data include a contract bytecode, an access information table, and/or an invoking information table. In a case in which contract Contract1 includes an access object but does not include invoking to another contract, the contract data include a contract bytecode and an access information table. In a case in which contract Contract1 does not include an access object but includes invoking to another contract, the contract data include a contract bytecode and an invoking information table. In a case in which contract Contract1 includes an access object and invoking to another contract, the contract data include a contract bytecode, an access information table, and an invoking information table.

Specifically, FIG. 10 is a schematic diagram of contract data in an embodiment of this specification. The contract data can include function data of functions in contract Contract1, and each piece of function data include a bytecode, an access information table, and an invoking information table that are corresponding to the function. As shown in FIG. 10, contract data of contract Contract1 include function data of function method1, function data of function method2, etc. The function data of function method1 are used as an example for description. The function data of function method1 include a bytecode, an access information table, and an invoking information table of the function. The access information table includes a plurality of read/write entries, each read/write entry corresponds to one state variable requested to be accessed in function method1, and the read/write entry includes an access mode and storage location information. The invoking information table includes a plurality of invoking entries. Each invoking entry corresponds to one-time invoking to another contract in function method1. The invoking entry includes a contract address of a contract invoked in function method1, a function name of the invoked contract, and an incoming parameter from function mehtod1 for the function of the invoked contract. It can be understood that contract data in this embodiment of this specification are not limited to those shown in FIG. 10.

It can be understood that each contract to be deployed is converted into contract data such as those shown in FIG. 10 before deployment, so as to be stored in a blockchain. For example, for contract Contract2 shown in FIG. 9, the contract data include function data corresponding to function method3, the function data include an access information table and an invoking information table of function method3, and the invoking information table includes invoking information for function method5 in contract Contract4.

After generating contract data such as contract data shown in FIG. 10 by using the compiler, the contract deployer can generate transaction Tx1 used to deploy contract Contract1, where a from field of transaction Tx1 is an account of the deployer, a to field is empty, and a data field includes contract data such as those shown in FIG. 10. The contract deployer can then send transaction Tx1 to the blockchain, so each node in the blockchain can receive transaction Tx1.

In S820, the contract data are stored in the blockchain.

After receiving transaction Tx1, and reaching consensus on transaction Tx1, the blockchain node can execute transaction Tx1, thereby deploying contract Contract1 in the blockchain. Specifically, referring to the above-mentioned description, the blockchain node determines the contract address of contract Contract1, and stores contract data in transaction Tx1 into the blockchain in association with the contract address. For example, with reference to the above-mentioned description of FIG. 4, state data of contract Contract1 are created in a state trie, a hash value of the contract data is recorded in a CodeHash field in the state data, and the contract data are stored in association with the hash value of the contract data, so the contract data of contract Contract1 can be read according to the CodeHash, and a bytecode, an access information table, or an invoking information table of each function can be read from the contract data.

According to the deployed contract shown in FIG. 8, for a transaction invoking the contract, the blockchain node can read contract data of the contract stored in the blockchain, and pre-read, according to information in the contract data, a state variable requested to be read by the contract, so as to improve transaction execution efficiency.

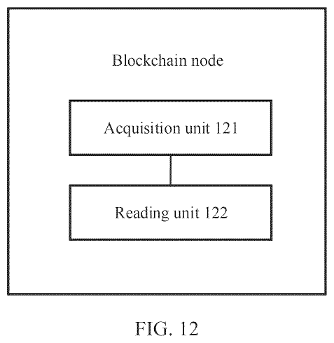

FIG. 11 is a flowchart illustrating a blockchain transaction execution method, according to some embodiments of this specification.

As shown in FIG. 11, in S110, transaction Tx2 is obtained, where a blockchain stores contract data of a contract invoked by transaction Tx2, and the contract data include storage location information of a state variable requested to be read by the contract.

For example, transaction Tx2 invokes contract Contract1. A transaction body of transaction Tx2 includes a from field, a to field, and a data field. The from field is a transaction sending account, the to field is a contract address of contract Contract1, and the data field is a function (such as function method1) in contract Contract1 invoked by transaction Tx2, and an incoming parameter for the function.

A blockchain node (e.g., master node) can receive transaction Tx2 from a client device, thereby obtaining transaction data of transaction Tx2. After receiving transaction Tx2 from the client device, the master node broadcasts transaction Tx2 to other nodes in the blockchain, so the nodes in the blockchain can obtain transaction Tx2 and separately perform the method in this embodiment of this specification. In the following, a certain node in the blockchain is used as an example for description, and the node can be any node in the blockchain.

As described above, contract Contract1 can be deployed in the blockchain by using the method shown in FIG. 8. Specifically, the blockchain stores contract data of contract Contract1, the contract data include an access information table, and the access information table includes, for example, storage location information of a plurality of state variables requested to be read by contract Contract1. Referring to the above-mentioned description, the access information table can further include storage location information of a state variable requested to be written by contract Contract1 and an access mode of each state variable in contract Contract1. In addition, the contract data can further include the above-mentioned invoking information table.

In S120, storage location information of a state variable requested to be read by contract Contract1 is read from the blockchain.

After obtaining transaction Tx2, the blockchain node reads the contract data of contract Contract1 from the blockchain according to the contract address of contract Contract1 invoked in transaction Tx2. Specifically, referring to FIG. 4, the blockchain node can read the state data of contract Contract1 from the state trie according to the contract address of contract Contract1, read the CodeHash from the state data, and read, according to the CodeHash, data corresponding to the CodeHash, that is, the contract data of the contract CodeHash. The contract data can include an access information table and/or an invoking information table of contract Contract1.

For example, as shown in FIG. 10, the contract data can include a bytecode, an access information table, and an invoking information table of each function in contract Contract1. The blockchain node can read the bytecode, the access information table, and the invoking information table of function method1 from the contract data, and obtain the storage location information of the state variable requested to be read by the contract from the access information table. Specifically, as described above, the access information table includes a plurality of read/write entries, and each read/write entry includes access location information and an access mode. The block link node can obtain, in the access information table, storage location information in each read/write entry in which the access mode is read or read/write, that is, storage location information of each state variable requested to be read by contract Contract1.

In S130, the value of the state variable is read according to the storage location information of the state variable requested to be read by contract Contract1.

In an implementation, the blockchain node can pre-read a state variable requested to be read by function method1 according to the access information table of function method1 and/or the invoking information table and the transaction body of transaction Tx2 before executing transaction Tx2. In an implementation, the blockchain node can pre-read the state variable requested to read by function method1 according to the access information table and/or the invoking information table of function method1 and the transaction body of transaction Tx2 after starting to execute transaction Tx2. By pre-reading the state variable, time for waiting to read a storage result is saved when transaction Tx2 is executed.

In addition, in a case in which a plurality of state variables are requested to be read for function method1, the blockchain node can read values of the plurality of state variables in parallel according to the access information table and/or the invoking information table of function method1 and the transaction body of transaction Tx2, thereby saving time for reading and storing. Specifically, the blockchain node can obtain, according to the access information table and/or the invoking information table of function method1 and the transaction body of transaction Tx2, a plurality of pieces of storage location information of the plurality of state variables to be read, and read the values of the plurality of state variables from the blockchain in parallel according to the plurality of pieces of storage location information.

Specifically, referring to FIG. 9 and FIG. 10, the blockchain node can generate storage keys of the one or more state variables in the state database (that is, the storage trie) according to the obtained storage location information of the state variable requested to be read by method1, and read values of the state variables from the state database according to the storage keys.

In a case, assume that the access information table includes a read/write entry of state variable A, where state variable A is a fixed-length variable, storage location information of the state variable A in the access information table can be a slot of the state variable included in the contract bytecode, and an access mode of the state variable A in the access information table is a read mode or a read/write mode. For state variable A, the blockchain node can combine the slot in the storage location information with a contract address (for example, concatenate) to obtain a storage key keyA of state variable A, and before the blockchain node performs a read operation on state variable A in transaction Tx2, pre-reads the value of state variable A from the state database according to the storage key keyA.

In another case, a state variable (for example, variable B) accessed by function method1 is a state variable corresponding to a mapping relationship, and storage location information of state variable B in the access information table can include parameter information associated with the mapping relationship and a slot of the mapping relationship in the contract bytecode. In a case in which the parameter information is used to indicate the transaction sending account or the transaction incoming parameter, the blockchain node can calculate the slot of state variable B based on the parameter information in the storage location information, the slot of the mapping relationship, and the transaction data of transaction Tx2, and calculate a storage key keyB of state variable B according to the slot of state variable B. For example, state variable B is the above-mentioned a[from], and storage location information thereof can include “slota, {index 0}. The blockchain node obtains the sending account of transaction Tx2 according to “index 0”, and can then calculate the slot of the state variable a[from] based on the sending account of transaction Tx2 and slota, so the storage key keyB of the state variable a[from] can be calculated based on the slot of the state variable a[from]. The blockchain node can calculate the slot of the state variable a[from] based on the sending account of transaction Tx2 and slota according to a predetermined rule, and the predetermined rule is determined based on the world state model. For example, as described above, the blockchain node can combine the sending account of transaction Tx2 with slota to obtain concatenated data, and obtain a hash value of the concatenated data, so as to obtain the slot of the state variable a[from]. It can be understood that different world state models can have different predetermined rules.

Then, the blockchain node can determine a storage key of the state variable a[from] based on the slot of the state variable a[from], and pre-read a value of the state variable a[from] from the state database according to the storage key of the state variable a[from].

If the function data of function method1 include the invoking information table corresponding to the invoking relationship shown in FIG. 9, the invoking information table includes an invoking entry corresponding to Contract2/method3 and an invoking entry corresponding to Contract3/method4.

For the invoking entry corresponding to Contract3/method4, the blockchain node reads contract data of contract Contract3 from the blockchain, and reads function data of function method4 from the contract data. Assume that the function data include an access information table of function method4. For the access information table of function method4, similar to the above-mentioned, the blockchain node determines, according to the access mode in the access information table of function method4 being read or the storage location information of the read state variable, a storage key of the state variable requested to be read in function method4, and pre-reads the value of the state variable from the state database according to the storage key. Specifically, in a case in which the storage location information of the state variable requested to be read in function method4 indicates an incoming parameter for function method4 in function method1, the blockchain node can determine, according to the read/write entry in the access information table of function method4 and the incoming parameter for function method4 in function method1, the storage key of the state variable requested to be read in function method4. For example, for state variable D in method4 and mapped to the incoming parameter according to the mapping relationship, the blockchain node can obtain a slot of state variable D by means of calculation based on the incoming parameter for function method4 in function method1 and the slot of the mapping relationship, calculate a storage key of state variable D based on the slot, and pre-read a value of state variable D from the state database based on the storage key.

For the invoking entry corresponding to Contract2/method3, the blockchain node reads contract data of contract Contract2 from the blockchain, and reads function data of function method3 from the contract data. Assume that the function data include an access information table and an invoking information table of function method3. For the access information table of function method3, similar to the above-mentioned, the blockchain node pre-reads the value of the state variable requested to be read by the function method3 according to the read/write entry in the access information table of function method3. For the invoking information table of function method3, referring to FIG. 9, the invoking information table includes an invoking entry corresponding to Contract4/method5, and the blockchain node can similarly read function data of function method5 in contract Contract4 according to the invoking entry, and pre-read, according to the function data, a value of a state variable requested to be read in function mehtod5. As such, the blockchain node can recursively pre-read the value of the state variable requested to be read in each invoking level in transaction Tx2.

In another implementation, the blockchain node can obtain a plurality of transactions, obtain contract data of contracts invoked by the plurality of transactions according to the plurality of transactions, and obtain, according to the contract data of the contracts invoked by the transactions, a plurality of pieces of storage location information of a plurality of state variables requested to be read by the plurality of transactions, so as to read values of the plurality of state variables in parallel according to the plurality of pieces of storage location information, thereby improving efficiency of executing the plurality of transactions in the blockchain.

Specifically, the blockchain node can determine read/write sets of the transactions according to access information tables and/or invoking information tables in the contract data of the contracts invoked by the plurality of transactions, and group the plurality of transactions according to the read/write sets of the transactions to obtain a plurality of transaction groups. The read/write set includes a read/write key of a state variable accessed by each transaction. Specifically, for state variable A accessed in transaction Tx2 in the above-mentioned, the blockchain node can use the storage key of state variable A (for example, a concatenation value of SlotA and the contract address) as a read/write key of state variable A in the read/write set of transaction Tx2. For the state variable a[from] accessed in transaction Tx2, in an implementation, the blockchain node can use the storage key of the state variable a[from] as a read/write key of the state variable a[from] in the read/write set of transaction Tx2. In another implementation, the blockchain node can use a concatenation value of slota and the contract address as a read/write key of the state variable a[from] in the read/write set of transaction Tx2.

The blockchain node can perform the following operations on each transaction group in parallel: obtain, according to access information tables and/or invoking information tables of a plurality of transactions in the transaction group, a plurality of pieces of storage location information of a plurality of state variables to be read corresponding to the transaction group, pre-read values of the plurality of state variables from the blockchain according to the plurality of pieces of storage location information, and execute the plurality of transactions in the transaction group based on the read values of the state variables. Specifically, the blockchain node can pre-read the values of the plurality of state variables from the blockchain according to the plurality of pieces of storage location information and the plurality of transactions.

In the above-mentioned method, the blockchain node can obtain, based on contract data of a contract pre-stored in the blockchain, a storage key of a state variable requested to be read by a transaction, and can pre-read a value of the state variable, or read the value of the state variable before a read operation on the state variable in the executed transaction after the transaction is started, thereby saving time waiting for a read result in a transaction execution process, improving transaction execution efficiency, and improving efficiency of the blockchain system. In addition, when the transaction requests to read a plurality of state variables, storage keys of the plurality of state variables to be read can be obtained based on the contract data, and the plurality of state variables can be read in batches according to the storage keys of the plurality of state variables, where the values of the plurality of state variables can be read in parallel in the batch reading, thereby saving time for waiting for a read result compared with reading the values of the plurality of state variables in series. In a case in which a plurality of transactions request to read a plurality of state variables, the blockchain node can obtain storage keys of the plurality of state variables to be read based on contract data of a contract invoked by the plurality of transactions, and similarly, read in batches the plurality of state variables according to the storage keys of the plurality of state variables, thereby saving transaction execution time and improving processing efficiency of the blockchain.

FIG. 12 is an architectural diagram illustrating a blockchain node, according to some embodiments of this specification. The blockchain node is configured to perform the method shown in FIG. 8 or FIG. 11 and includes: an acquisition unit 121, configured to obtain a first transaction, where the first transaction invokes a first contract, contract data of the first contract is stored in a blockchain, the contract data includes a first access information table, and the first access information table includes first storage location information of a first state variable requested to be read by the first contract; and a reading unit 122, configured to read the first storage location information from the blockchain, and read a value of the first state variable from the blockchain based on the first storage location information, to execute the first transaction.

An embodiment of this specification further provides a computer readable storage medium that stores a computer program, and when the computer program is executed in a computer, the computer is enabled to perform the method shown in FIG. 8 or FIG. 11.

An embodiment of this specification further provides a blockchain node, including a memory and a processor, where the memory stores executable code, and when the processor executes the executable code, the method shown in FIG. 8 or FIG. 11 is implemented.

In the 1990s, whether improvement to a technology is hardware improvement (for example, improvement to a circuit structure like a diode, a transistor, or a switch) or software improvement (improvement to a method procedure) can be clearly identified. However, with development of technologies, improvement to many existing method procedures can be considered as direct improvement to hardware circuit structures. Almost all designers get the corresponding hardware circuit structure by programming the improved method flow into the hardware circuit. Hence, it cannot say that an improvement of a method flow cannot be implemented using a hardware entity module. For example, a Programmable Logic Device (PLD), such as a Field Programmable Gate Array (FPGA), is such an integrated circuit whose logic functions are determined by the user programming the device. By the designer's own programming to “integrate” a digital system on a PLD, without asking the chip manufacturer to design and produce a special integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. Persons skilled in the art should also know that only by using the above-mentioned hardware description languages to perform a little logic programming on the method flow and programming same into the integrated circuit, the hardware circuit for realizing the logic method flow can be easily obtained.

The controller can be implemented in any appropriate way, for example, the controller can be in the form of, for example, a microprocessor or processor and a computer readable medium, logic gates, switches, an Application Specific Integrated Circuit (ASIC), programmable logic controllers, and embedded microcontrollers, which store the computer readable program code (for example, software or firmware) that can be executed by the (micro)processor. Examples of the controller include, but are not limited to, the following microcontrollers: ARC 625D, Atmel AT91SAM, Microchip PIC18F26K20, and Silicone Labs C8051F320. The memory controllers can also be implemented as part of the memory control logic. It is also known to persons skilled in the art that, in addition to implementing the controller in a purely computer-readable program code manner, it is entirely possible to perform the same functions of the controller in the form of logic gates, switches, ASIC, programmable logic controllers, embedded microcontrollers etc. by logic programming the method steps. Hence, this controller can be considered to be a hardware component, while an apparatus included therein for implementing various functions can also be considered as the structure in the hardware component. Or the apparatus for implementing various functions can even be considered as both a software module for implementing a method and the structure in the hardware component.

The system, apparatus, module, or unit stated in the embodiments above can specifically be implemented using a computer chip or entity, or can be implemented by a product having a certain function. A typical implementing device is a server system. Of course, this application does not exclude that with the development of computer technology in the future, the computer that implements the functions of the above-mentioned embodiments may, for example, be a personal computer, a laptop computer, a vehicular human-computer interaction device, a cellular phone, a camera phone, a smart phone, a personal digital assistant, a media player, a navigation device, an E-mail device, a game console, a tablet computer, a wearable device, or a combination of any of these devices.

Although one or more embodiments of this specification provide method operating steps as described in an embodiment or a flowchart, more or fewer operating steps can be included on the basis of conventional or noncreative means. The sequence of steps enumerated in the embodiments is only one way among a plurality of step execution sequences and does not represent a unique sequence of execution. When executed in an actual apparatus or end product, it can be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a set of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, etc. are used for indicating names, they do not indicate any particular order.

For the convenience of description, the above-mentioned apparatuses are divided into various modules according to functions for respective descriptions. Of course, when implementing one or more of this specification, functions of various modules can be realized in the same or more software and/or hardware, and the modules that achieve the same function can also be realized by a combination of a plurality of sub-modules or sub-units. The apparatus embodiments described above are only schematic, for example, the division of units is only a logical function division; in actual implementation, there can be other ways of division; for example, a plurality of units or assemblies can be combined or can be integrated into another system, or some features can be omitted, or not performed. On the other hand, the coupling or direct coupling or communicative connection between each other shown or discussed can be indirect coupling or communicative connection through some interfaces, apparatuses or units, and can be in electrical, mechanical or other forms.

The present disclosure is described with reference to the flowchart and/or block charts of methods, apparatuses (systems), and computer program products according to the embodiments of the present disclosure. It should be understood that each process and/or box in a flowchart and/or block chart, and combinations of processes and/or boxes in the flowchart and/or block chart, can be implemented by computer program instructions. These computer program instructions can be provided to processors of a general-purpose computer, a special purpose computer, an embedded processor, or other programmable data processing devices, to produce a machine, so the instructions executed by the processors of the computer or other programmable data processing devices generate an apparatus for implementing functions specified in one or more processes of a flowchart and/or one or more boxes of a block chart.

These computer program instructions can also be stored in a computer-readable memory that can guide a computer or another programmable data processing device to operate in a particular manner, such that the instructions stored in the computer readable memory produce an article of manufacture including an instruction apparatus, and the instruction apparatus implements the functions specified in the one or more processes of the flowchart and/or the one or more boxes of the block chart.

These computer program instructions can also be loaded to a computer or another programmable data processing device, so a series of operating steps are executed on the computer or another programmable data processing device, to generate the processing implemented by the computer, and therefore, the instructions executed on the computer or another programmable data processing device provide steps of implementing the functions specified in the one or more processes of the flowchart and/or the one or more boxes of the block chart.

The computer-readable medium includes persistent, non-persistent, movable, and unmovable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions executed by a computer, for example, a program module. Usually, the program module includes a routine, a program, an object, a component, a data structure, etc. for executing a specific task or implementing a specific abstract data type. The one or more embodiments of this specification can alternatively be practiced in distributed computing environments. In the distributed computing environments, tasks are executed by remote processing devices that are connected through a communication network. In the distributed computing environments, the program module can be located in both local and remote computer storage media including storage devices.

The embodiments in this specification are described in a progressive way. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments. In the descriptions of this specification, descriptions of reference to terms such as “an embodiment”, “some embodiments”, “an example”, “a specific example”, or “some examples” mean that specific features, structures, materials, or characteristics described with reference to the embodiment or example are included in at least one embodiment or example of this specification. In this specification, illustrative expressions of the above-mentioned terms are not necessarily intended for the same embodiment or example. In addition, the described specific feature, structure, material, or characteristic can be combined in a proper manner in any one or more embodiments or examples. Moreover, a person skilled in the art can combine and associate different embodiments or examples and features of different embodiments or examples described in this specification, provided that the embodiments or examples and the features do not conflict with each other.

The above-mentioned descriptions are merely embodiments of the one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

What is claimed is:

1. A computer-implemented method, performed by a blockchain node, wherein the method comprises:
obtaining a first transaction, wherein the first transaction invokes a first contract, contract data of the first contract is stored in a blockchain, the contract data comprises a first access information table, and the first access information table comprises first storage location information of a first state variable requested to be read by the first contract;
reading the first storage location information from the blockchain; and
reading a value of the first state variable from the blockchain based on the first storage location information, to execute the first transaction.

2. The computer-implemented method according to claim 1, wherein:
the first access information table comprises a plurality of pieces of first storage location information of a plurality of first state variables requested to be read by the first contract,
the reading the first storage location information from the blockchain comprises: reading the plurality of pieces of first storage location information from the blockchain, and
the reading a value of the first state variable from the blockchain based on the first storage location information comprises: reading values of the plurality of first state variables from the blockchain in parallel based on the plurality of pieces of first storage location information.

3. The computer-implemented method according to claim 2, wherein:
the obtaining a first transaction comprises: obtaining a plurality of first transactions,
the reading the first storage location information from the blockchain comprises: reading, from the blockchain, a plurality of pieces of first storage location information corresponding to the plurality of first transactions, and
the reading a value of the first state variable from the blockchain based on the first storage location information comprises: reading values of the plurality of first state variables from the blockchain in parallel based on the plurality of pieces of first storage location information.

4. The computer-implemented method according to claim 3, wherein:
the first access information table further comprises second storage location information of a second state variable requested to be written by the first contract;
the computer-implemented method further comprises: grouping the plurality of first transactions based on the first storage location information and the second storage location information of the plurality of first transactions, to obtain a plurality of transaction groups; and
the reading a value of the first state variable from the blockchain based on the first storage location information comprises:
before a first transaction group in the plurality of transaction groups is executed, reading, from the blockchain based on the plurality of pieces of first storage location information corresponding to the first transaction group, values of a plurality of first state variables corresponding to the first transaction group.

5. The computer-implemented method according to claim 1, wherein the contract data comprises first function data corresponding to a first function in the first contract, the first function data comprises the first access information table, and the first access information table comprises storage location information of the first state variable requested to be read by the first function.

6. The computer-implemented method according to claim 5, wherein the storage location information of the first state variable is obtained based on at least one of: location information of the first state variable in contract code, a name of the first state variable, or a length of the first state variable.

7. The computer-implemented method according to claim 1, wherein the first state variable is mapped to first information in the first transaction based on a mapping relationship, the first storage location information comprises an identifier of the mapping relationship and second information, and the second information is used to indicate the first information; and
the reading a value of the first state variable from the blockchain based on the first storage location information comprises:
obtaining the first information from the first transaction based on the second information, and reading the value of the first state variable based on the identifier of the mapping relationship and the first information.

8. The computer-implemented method according to claim 5, wherein the first function comprises invoking of a second contract, the first function data comprises first invoking information corresponding to the second contract, and the first invoking information comprises an address of the second contract and a function name of a second function in the second contract; and
the computer-implemented method further comprises:
reading the first invoking information from the blockchain, and
reading, from the blockchain based on the address of the second contract and the function name of the second function in the first invoking information, second function data corresponding to the second function, wherein the second function data comprises a second access information table, and the second access information table comprises third storage location information of a third state variable requested to be read by the second function; and
reading a value of the third state variable based on the third storage location information, to execute the first transaction.

9. The computer-implemented method according to claim 8, wherein the first invoking information further comprises an incoming parameter from the first function for the second function; and
the reading a value of the third state variable based on the third storage location information comprises:
reading the value of the third state variable based on the third storage location information and the incoming parameter.

10. The computer-implemented method according to claim 1, wherein the computer-implemented method further comprises:
receiving a second transaction, wherein the second transaction is used to deploy the first contract, and the second transaction comprises the contract data of the first contract; and
storing the contract data of the first contract in the blockchain based on the second transaction.

11. The computer-implemented method according to claim 1, wherein the first access information table further comprises an access mode of a state variable requested to be accessed by the first contract.

12. The computer-implemented method according to claim 7, wherein the first contract corresponds to a plurality of numbers arranged in numerical order, the identifier of the mapping relationship comprises a first number in the plurality of numbers, the first number is determined based on a declaration location of the mapping relationship in the first contract, and the first information comprises a sending account of the first transaction or an incoming parameter from the first transaction for the first contract; and
the reading the value of the first state variable based on the identifier of the mapping relationship and the first information comprises:
determining a second number of the first state variable based on the sending account of the first transaction or the incoming parameter from the first transaction for the first contract, and the first number; and
reading the value of the first state variable from the blockchain based on the second number.

13. A blockchain node, comprising:
one or more processors; and one or more tangible, non-transitory, machine-readable media storing one or more instructions that, when executed by the one or more processors, perform one or more operations comprising:
obtaining a first transaction, wherein the first transaction invokes a first contract, contract data of the first contract is stored in a blockchain, the contract data comprises a first access information table, and the first access information table comprises first storage location information of a first state variable requested to be read by the first contract;
reading the first storage location information from the blockchain; and
reading a value of the first state variable from the blockchain based on the first storage location information, to execute the first transaction.

14. The blockchain node according to claim 13, wherein:
the first access information table comprises a plurality of pieces of first storage location information of a plurality of first state variables requested to be read by the first contract,
the reading the first storage location information from the blockchain comprises: reading the plurality of pieces of first storage location information from the blockchain, and
the reading a value of the first state variable from the blockchain based on the first storage location information comprises: reading values of the plurality of first state variables from the blockchain in parallel based on the plurality of pieces of first storage location information.

15. The blockchain node according to claim 13, wherein the contract data comprises first function data corresponding to a first function in the first contract, the first function data comprises the first access information table, and the first access information table comprises storage location information of the first state variable requested to be read by the first function.

16. The blockchain node according to claim 13, wherein the first state variable is mapped to first information in the first transaction based on a mapping relationship, the first storage location information comprises an identifier of the mapping relationship and second information, and the second information is used to indicate the first information; and
the reading a value of the first state variable from the blockchain based on the first storage location information comprises:
obtaining the first information from the first transaction based on the second information, and reading the value of the first state variable based on the identifier of the mapping relationship and the first information.

17. The blockchain node according to claim 13, wherein the one or more operations further comprise:
receiving a second transaction, wherein the second transaction is used to deploy the first contract, and the second transaction comprises the contract data of the first contract; and
storing the contract data of the first contract in the blockchain based on the second transaction.

18. The blockchain node according to claim 13, wherein the first access information table further comprises an access mode of a state variable requested to be accessed by the first contract.

19. A non-transitory, computer-readable medium storing one or more instructions executable by a computer system to perform operations comprising:
obtaining a first transaction, wherein the first transaction invokes a first contract, contract data of the first contract is stored in a blockchain, the contract data comprises a first access information table, and the first access information table comprises first storage location information of a first state variable requested to be read by the first contract;
reading the first storage location information from the blockchain; and
reading a value of the first state variable from the blockchain based on the first storage location information, to execute the first transaction.

20. The non-transitory, computer-readable medium according to claim 19, wherein the first access information table further comprises an access mode of a state variable requested to be accessed by the first contract.
